(19) United States
(12) Patent Application Publication
(10) Pub. No.: US 2018/0002956 A1
(43) Pub. Date: Jan. 4, 2018

(54) ACTUATABLE DOOR STOP

(71) Applicant: James Tran, Rosemead, CA (US)

(72) Inventor: James Tran, Rosemead, CA (US)

(21) Appl. No.: 15/636,268

(22) Filed: Jun. 28, 2017

Related U.S. Application Data
(60) Provisional application No. 62/357,990, filed on Jul. 2, 2016.
(60) Provisional application No. 62/482,109, filed on Apr. 5, 2017.

(51) Int. Cl. E05C 19/00

(52) U.S. Cl. CPC E05C 19/004

(57) ABSTRACT

A door stopper device having a base securable to the floor adjacent to the door, and a stepper plate pivotally attachable to the base. A stopper plate is pivotally attached to the base and the stepper plate, with the stopper plate having a distal end portion opposite the stepper plate. The distal end portion of the stopper plate is raised upward and is engageable with the door when the door stopper device is in an engaged position, and the distal end of the stopper plate is lowered from the engaged position to assume a disengaged position, the stopper plate is not engageable with the door when the door stopper device is in the disengaged position.

### CROSS-REFERENCE TO RELATED APPLICATIONS

This application claims the benefit of U.S. Provisional Application No. 62/357,990, filed Jul. 2, 2016 and U.S. Provisional Application No. 62/482,109, filed Apr. 5, 2017, the contents of both of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a door stopper, and more specifically, to a door stopper having a selectively deployable stopper plate adapted to engage with a door for limiting movement of the door toward its open position.

### 2. Description of the Related Art

Securing a home, apartment, hotel room or other personal space from an intruder is important for protecting personal possessions, as well as to protect against physical harm. Indeed, most doors are equipped with some form of locking mechanism which maintains the door in its closed position. For instance, deadbolts or handle locks are commonly used on doors to lock the door. When the deadbolt or handle lock is “engaged,” a person entering the door from the outside is typically prevented from entering. In order to enter through the door, the deadbolt or handle lock may be “disengaged” to allow the door to transition from the closed position to the open position.

In many cases, the locking mechanism may allow anyone located on the “inside” of the door to selectively transition the locking mechanism between the engaged and disengaged positions, while only permitting an individual in possession of a key to control the locking mechanism from the outside. As such, conventional locking mechanisms are effective in performing their intended functionality when the door is in its closed position.

However, such conventional locking mechanisms tend to be ineffective at restrictive movement of the door when the door has been moved out of its closed position to a slightly ajar position. For instance, when one hears a doorbell or a knock on the door, an individual may unlock any locking mechanism and move the door to the slightly ajar position to see who may be outside. At this point, the individual may be susceptible to being overpowered by an intruder.

Accordingly, there is a need in the art for a door stopper which can be easily deployed for restricting movement of a door from a slightly ajar position toward a fully open position. Various aspects of the present disclosure address this particular need, as will be discussed in more detail below.

### BRIEF SUMMARY

In accordance with one embodiment of the present disclosure, there is provided a door stopping device for blocking a door from transitioning toward an open position. The door stopping device is selectively deployable by an operator located on the side of the door toward which the door pivots as the door transitions from its closed position toward its open position. In this regard, the door stopping device provides the operator with control over opening of the door to restrict unwanted entry through the door.

According to one embodiment, the door stopper device includes a base securable to the floor adjacent to the door, and a stepper plate pivotally attachable to the base. A stopper plate is pivotally attached to the base and the stepper plate, with the stopper plate having a distal end portion opposite the stepper plate. The distal end portion of the stopper plate is raised upward and is engageable with the door when the door stopper device is in an engaged position, and the distal end of the stopper plate is lowered from the engaged position to assume a disengaged position, the stopper plate is not engageable with the door when the door stopper device is in the disengaged position.

The stepper plate may be flush with the base when the door stopper device is in the disengaged position.

The base may include at least one cavity to receive portions of the stepper plate and the stopper plate.

The stepper plate and the stopper plate may be sized and structured such that the distal end portion of the stopper plate moves in a first direction upon application of a force to the stepper plate in an opposing second direction.

The door stopper device may additionally include a first pin affixed to the base and about which the stopper plate pivots. The stopper plate may be translatable relative to the first pin. The stopper plate may include a slot sized to receive the first pin and facilitate translation of the stopper plate relative to the first pin. The door stopper device may additionally include a second pin affixed to the base and about which the stepper plate pivots. The door stopper device may further include a third pin pivotally connecting the stopper plate to the stepper plate.

The base may circumnavigate the stepper plate and the stopper plate.

According to another embodiment, there is provided a door stopper device for use with a door. The door stopper device includes a base defining a base plane, and a press plate moveably engaged to the base. A stopper plate is operatively coupled to the press plate and includes a distal end portion. The stopper plate is transitional relative to the base between a disengaged position and an engaged position, with a distance between the distal end portion and the base plane increasing as the stopper plate transitions from the disengaged position toward the engaged position.

The press plate may be parallel to the base plane when the stopper plate is in the disengaged position. The press plate may be non-parallel relative to the base plane when the stopper plate is in the engaged position.

According to yet another embodiment, there is provided a method of inhibiting movement of a door. The method includes pivoting a press plate relative to a base from a first position toward a second position. The press plate is operatively connected to a stopper plate, such that pivoting of the press plate from the first position toward the second position causes the stopper plate to transition from a disengaged position toward an engaged position wherein the stopper plate is engageable with the door for inhibiting movement of the door.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of an embodiment of a door stopper device in an engaged position for inhibiting the movement of a door toward its open position;

FIG. 2 is a cross sectional upper perspective view of the door stopper device depicted in FIG. 1;

FIG. 3 is a cross sectional upper perspective view of the door stopper device in a disengaged position;

FIG. 4 is an exploded upper perspective view of the door stopper device depicted in FIG. 1;

FIG. 5 is an upper perspective view of the door stopper device in the disengaged position;

FIG. 6A is a perspective view of a stopper plate of the door stopper device;

FIG. 6B is a top view of the stopper plate;

FIG. 6C is a rear view of the stopper plate;

FIG. 6D is a side view of the stopper plate;

FIG. 7A is a perspective view of a stepper plate of the door stopper device;

FIG. 7B is a top view of the stepper plate;

FIG. 7C is a rear view of the stepper plate;

FIG. 7D is a side view of the stepper plate;

FIG. 8A is a lower perspective view of a base of the door stopper device;

FIG. 8B is a top view of the base;

FIG. 8C is a rear view of the base;

FIG. 8D is a side view of the base;

FIG. 9A is an upper perspective view of a second embodiment of a door stopper device having a brace;

FIG. 9B is a top view of the door stopper device depicted in FIG. 9A;

FIG. 9C is a rear view of the door stopper device depicted in FIG. 9A; and

FIG. 9D is a side view of the door stopper device depicted in FIG. 9A.

Common reference numerals are used throughout the drawings and the detailed description to indicate the same elements.

### DETAILED DESCRIPTION

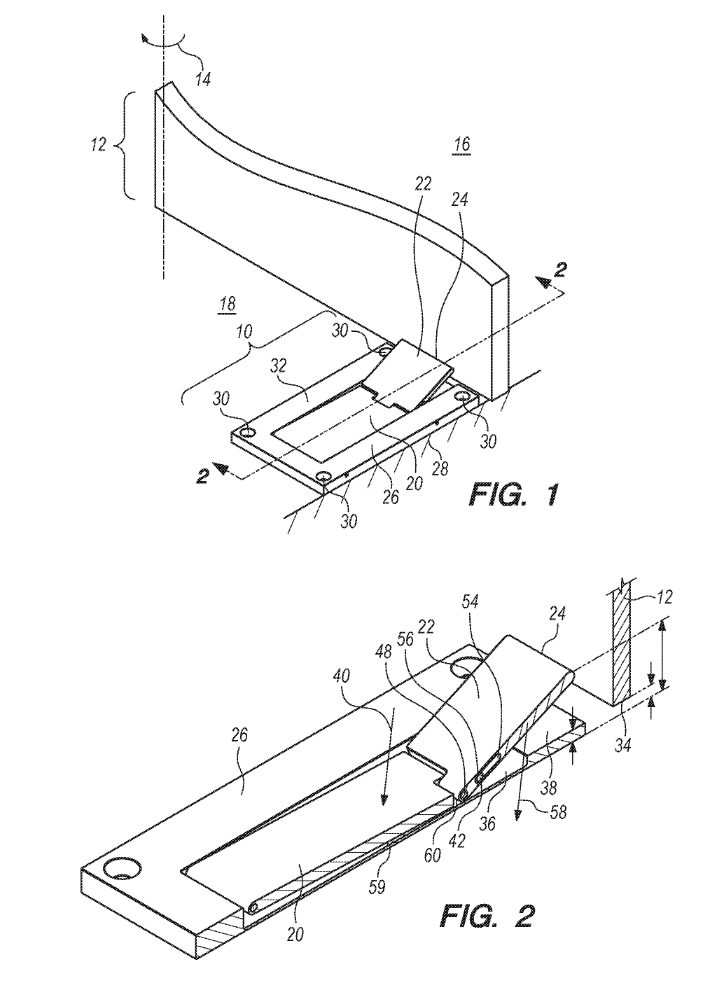

Referring now to the drawings, a door stopper device 10 is shown. The door stopper device may be installed in front of a door 12 so that when a person on the other side or the distal side 16 of the door attempts to push the door open in the direction of rotational arrow 14, the door does not hit a person on a proximal side 18 when the door stopper device 10 is in the engaged position as shown in FIG. 1. The person on the proximal side pushes down on a stepper plate 20 (i.e., a press plate) which in turn raises a stopper plate 22. A distal end 24 is raised high enough in order to block the door 12 so that the door 12 cannot be rotated in the direction of arrow 14. A person that wants to pass through the doorway by opening the door 12 from the proximal side 18 to the distal side 16 first steps on the stepper plate 20 which prevents the door 12 from being traversed toward the person on the proximal side, grips the handle, releases the stepper plate 20 so that the door stopper device 10 no longer prevents the door 12 from swinging open toward the proximal side then opens the door with the handle. In this way, the person on the proximal side of the door 12 maintains control of the door at all times.

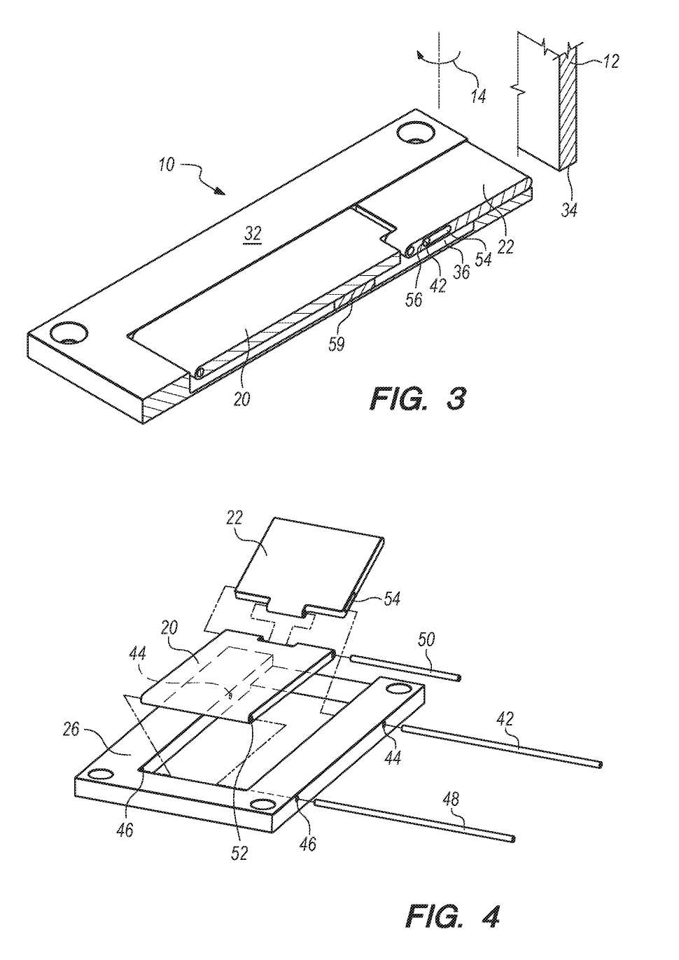

Referring now more particularly to FIG. 1, the door stopper device 10 is shown in the engaged position so that the door 12 cannot be rotated in the direction of arrow 14. The door stopper device 10 has a base 26. The base 26 receives the stepper plate 20 and the stopper plate 22. Moreover, the stepper plate 20 and the stopper plate 22 are secured to a floor 28 by way of the base 26. By way of example and not limitation, the base 26 may have four countersunk holes 30. Screws may be received into the countersunk holes 30 and have countersunk heads so that a top surface of the screws lay flush with a top surface 32 of the base 26. The screws may be screwed into the floor. Additionally or alternatively, the base may be adhered to the floor. It is also contemplated that the floor may be recessed and the base disposed within the recess to hold the device in place during use. The floor may have a recess that can snugly receive the base 26 in that the device does not move around excessively within the recess. Also, the floor may be defined by a concrete surface or carpet. In either case, the recess may be formed in the concrete or the carpet may be cut to receive the base of the device. The top surface 32 of the base 26 may be flat. When the stepper plate 20 is pushed down as shown in FIG. 1 and the stopper plate 22 is raised up, the distal end 24 of the stopper plate 22 is raised sufficiently high in order to contact the door 12 if the door 12 is rotated toward the proximal side. However, when the stepper plate 20 is not pushed down but is raised up, the stopper plate 22 is lowered as shown in FIG. 3, the stopper plate 22 and the stepper plate 20 is preferably flush or below the top surface 32 of the base 26. However, it is also contemplated that the stepper plate 20 and the stopper plate 22 may reside above the top surface 32 of the base 26 but in no instance would it be above a lower edge 34 (see FIG. 3) of the door 12. The reason is that this would allow the door 12 to swing toward the proximal side in the direction of arrow 14 when the door stopper device 10 is in the disengaged position, as shown in FIG. 3.

The base 26 may be fabricated from a single piece of material, preferably metallic. The material selection of the base 26 and its thickness is selected in order to withstand any forces imposed on the stopper plate 22 by the door 12 in the event someone on the distal side 16 attempts to push open the door when the user is trying to walk through the door from the proximal side to the distal side. The base 26 defines a base plane and preferably has first and second cavities 36, 38 (see FIGS. 2 and 3) extending into the base 26 from the base plane. The cavity 38 receives the distal end portion of the stopper plate 22, as shown in FIG. 3 when the door stopper device 10 is in the disengaged position (see FIG. 3). Moreover, the cavity 36 receives the distal end portion of the stepper plate 20 and the proximal portion of the stopper plate 22 when a downward force 40 is applied to the distal portion of the stepper plate 20. The distal end 24 raises upward when the downward force 40 is applied because there is a fixed pin 42 about which the stopper plate 22 pivots when the downward force 40 is applied. The base 26 may additionally have holes 44, 46. The holes 44, 46 receive fixed pins 42, 48. (See FIG. 4).

Referring now to FIG. 4, the door stopper device 10 may be assembled by first pivotally attaching the stepper plate 20 to the stopper plate 22 with a pivot pin 50. The pivot pin 50 only secures the stepper plate 20 to the stopper plate 22. The pivot pin 50 does not contact the base 26. After the pivot pin 50 is used to pivotally join the stopper plate 22 and the stepper plate 20, the fixed pin 48 may be inserted into hole 46 of the base 26 and hole 52 of the stepper plate 20. The pin 48 extends from one side of the base 26 to the other side of the base 26 so that the stepper plate 20 is pivotally attached to the base with the fixed pin 48 forming a rotational axis of the stepper plate 20. The fixed pin 42 may then be inserted into hole 44 and slot 54 of the stopper plate 22. The pin 42 extends across both sides of the stopper plate 22 and engages both sides of the base 26 so that the stopper plate 22 pivots about the pin 42 and slides within the slot 54.

The sliding of the pin 42 inside slot 54 is shown by comparing FIGS. 2 and 3. As shown in FIG. 2, there is a slight gap between the pin 42 and a proximal end 56 of the slot 54. In contrast, the pin 42 shown in FIG. 3 is closer to the proximal end 56 of the slot 54.

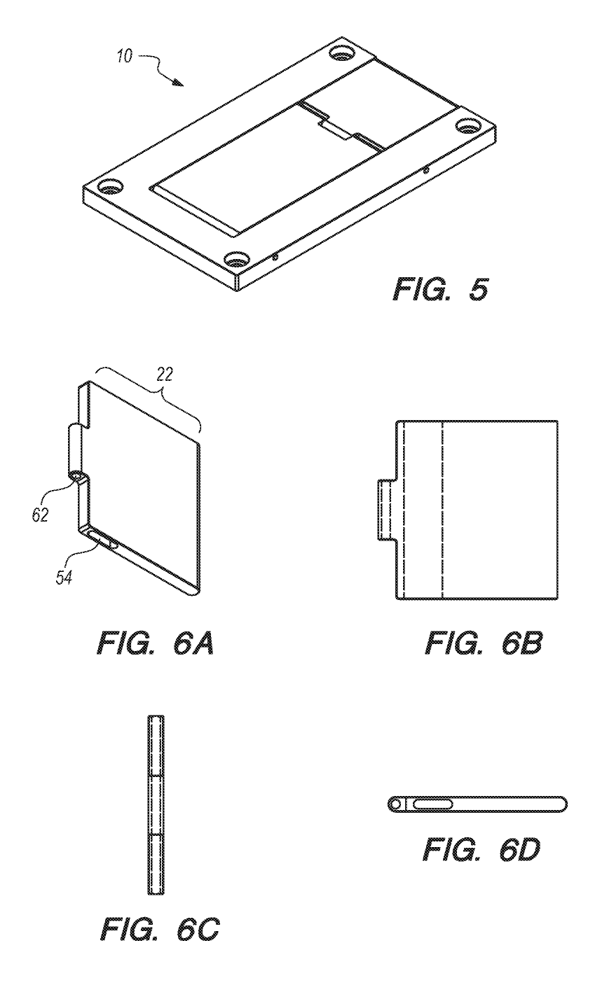

Referring now to FIGS. 1 and 5, the door stopper device 10 is shown both in the engaged position (see FIG. 1) and the disengaged position (see FIG. 5). The door stopper device 10 operates based on user actuation (i.e. pushing down on the stepper plate 20) to traverse the device 10 to the engaged position and releasing the stepper plate 20 which in turn traverses the stopper plate 22 back down to a lowered position. When the user depresses the stepper plate 20, the user applies a downward force 40 (see FIG. 2) with his or her foot. In doing so, the pivot joint defined by pin 50 is urged downward. The pin 42 is a fixed pin and acts as a fulcrum so that the stopper plate 22 pivots upward, and more particularly, the distal end 24 of the stopper plate 22 traverses upward, as shown in FIGS. 1 and 2. The device 10 is now in the engaged position. The door 12 cannot be opened because the stopper plate 22 will stop the door 12 from being rotated open.

The user may now confidently grip the handle of the door 12 with full confidence that the user will not be hit by the door when a person on the other side of the door quickly and with great force pushes the door open. In the event that a person on the other side of the door pushes the door with great force, the stopper plate 22 prevents the door from opening and hitting the user. After the user grips the handle, the user may now release the stepper plate 20 and utilize his or her hands to stop the door from opening quickly and hitting the user. The user may now open the door 12 with the handle with confidence knowing that he/she will not be hit by the door.

When the user releases the stepper plate 20, the stopper plate 22 is traversed downward until the door 12 can pass over the device 10. The stopper plate 22 may be traversed under the weight of gravity. The stopper plate 22 may be fabricated from a sufficiently heavy material so that a weight force 58 (see FIG. 2) of the stopper plate 22 traverses the stopper plate 22 back to the down position fast enough so that there is no perceivable delay by the user in releasing the stepper plate 20 and opening the door with the handle. Additionally, to further assist in the speed at which the stopper plate 22 is traversed back to the down position, the stepper plate 20 may be fabricated from a different and lighter material compared to the material from which the stopper plate 22 is fabricated from. By way of example and not limitation, the stepper plate 20 may be fabricated from a plastic injection material, whereas, the stopper plate 22 may be fabricated from a metallic material including but not limited to aluminum, steel, stainless steel. Additionally, weights may be added to the stopper plate 22 to further speed the transition from the up position to the down position. The weights may be added to a lower side of the stopper plate 22 near the distal end 24. In order to accommodate the weights, the cavity 38 may be enlarged by milling down the base 26 at that portion of the base 26. Additionally and alternatively, weights may be added to the top side of the stopper plate 22 so long as the weights do not hit the door 12 when the device 10 is in the disengaged position.

It is also contemplated that the stopper plate 22 may be fabricated from a lighter material such as those used to fabricate the stepper plate 20.

Additionally, the stopper plate 22 may be traversed back to the down position at the aid of a spring. The spring may be an extension spring attached to the distal end portion of the stopper plate 22 and the base 26 in order to drive the stopper plate 22 with a downward force. Also, the spring may be a torsion spring is attached to the stepper plate 20 and the stopper plate 22. The torsion spring may be disposed about pin 48. The spring return mechanism may be useful when the stopper plate 22 is fabricated from a lighter material and the weight of the stopper plate may not be sufficient to drive the stopper plate 22 back downward when the user releases the stepper plate 20. The spring may also be a flat spring including but not limited to a DIN Disc (2093), Belleville, Clover® Dome, Curved, Finger, Wave, and Multi-Wave types of flat springs. The flat spring may also have a round or circular shape but also have an elongate shape similar to a leaf spring. The flat spring 59 may be disposed between the stepper plate 20 and the floor of the cavity 36 of the base 26, as shown in FIGS. 2 and 3. The flat spring may be located in a recess in either one or both of the floor of the cavity 36 of the base and the bottom surface of the stepper plate 20.

The device 10 also operates to prevent opening of the door when the device 10 is in the engaged position. When the device 10 is in the engaged position and the door is swung open, the stopper plate 22 engages the door and stops the door from opening. The door 12 must be swung back to the closed position and preferably closed in order to traverse the device 10 the back to disengaged position. The reason is that the stopper plate 22 pivots about a fulcrum defined by pin 42. Because the stopper plate 22 pivots, in order for the stopper plate 22 to pivot back down to the down position or disengaged position, the distal end 24 of the stopper plate 22 must move forward toward the door 12 and the door swung back to the closed position.

The stopper plate 22 stops the door 12 because a proximal end 60 contacts a bottom surface of the cavity 36 defined by the base 26. If the cavity 36 is a through hole, then the proximal end 60 would contact the floor to which the device 10 is attached to. However, preferably the distal end 60 contacts a bottom surface of the cavity 36 so that the distal end 60 does not damage the floor over repeated use. The force of the door 12 is stopped by a torque created by the forces at pin 48 and 42. It is also contemplated that the stopper plate 22 may stop the door 12 from opening by forces generated solely at pin 42. To this end, the proximal end 60 of the stopper plate 22 is not allowed to contact the floor of the cavity 36 or the floor to which the device 10 is attached to. To prevent the proximal end 60 of the stopper plate 22 from making contact with the surface, the door 12 may be formed with a recess which receives the distal end 24 of the stopper plate 22 when the stopper plate is raised upward. Instead of or in addition to a recess, the door may have a plate attached to the door 12 at a level so that the distal end engages the underside of the plate and the door 12 when the other person on the other side attempts to open the door 12. A bottom side of the distal end 60 may have a sponge material to prevent the distal end 60 from fully engaging or contacting a hard surface of the base 26 or the floor to which the device 10 is attached. The resilient material provides sufficient leeway so that when the user steps down on the stepper plate and the door 12 is opened, the distal end 24 may ride up on the face of the door 12 and be stopped by the groove or plate mounted to the door 12 before distal end 60 touches the surface. At this position, the resilient material or sponge material is not fully compressed.

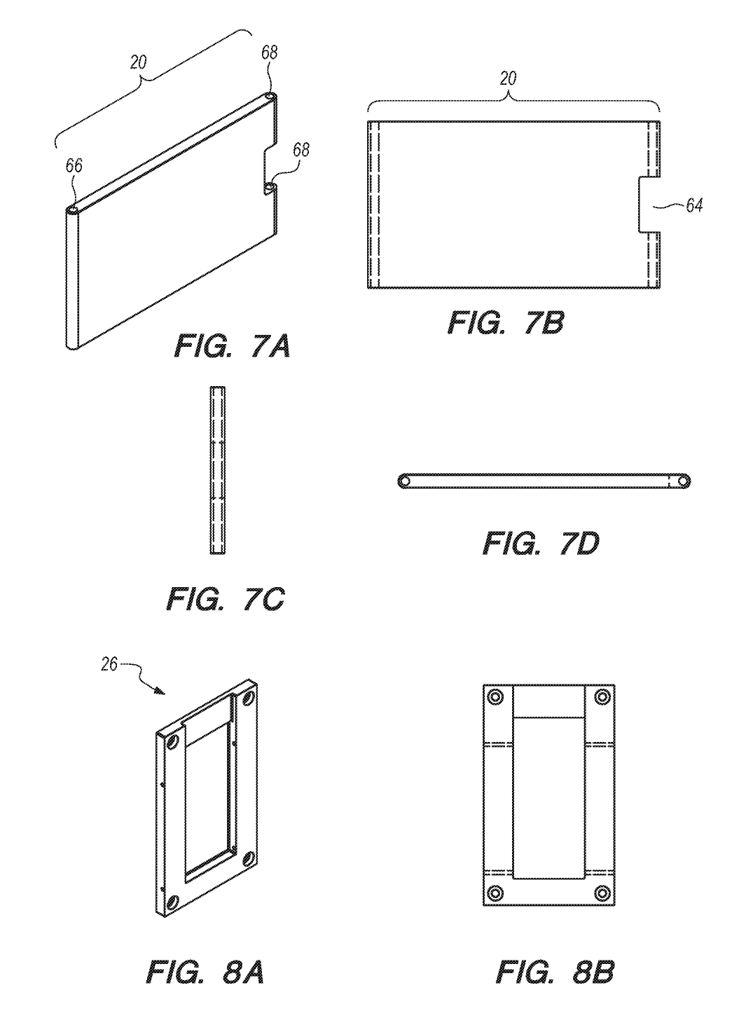

Referring now to FIGS. 6A-6D, the stopper plate 22 is shown. The stopper plate may have slot 54 that receives pin 42. The stopper plate 22 may have a stepped configuration at its proximal end portion and be receivable into a notch 64 (see FIG. 7B) of the stepper plate 20. FIG. 6B is a front view of the stopper plate 22. Figured 6C is a right side view of the stopper plate 22. FIG. 6D is a top view of the stopper plate 22.

Referring now to FIG. 7A, the stepper plate 20 is shown. The stepper plate may have a hole 66 that receives pin 48 and hole 68 that receives pin 50. FIG. 7A is a perspective of the stepper plate 20. FIG. 7B is a front view of the stepper plate 20. FIG. 7C is a right side view of the stepper plate 20. FIG. 7D is a top view of the stepper plate 20.

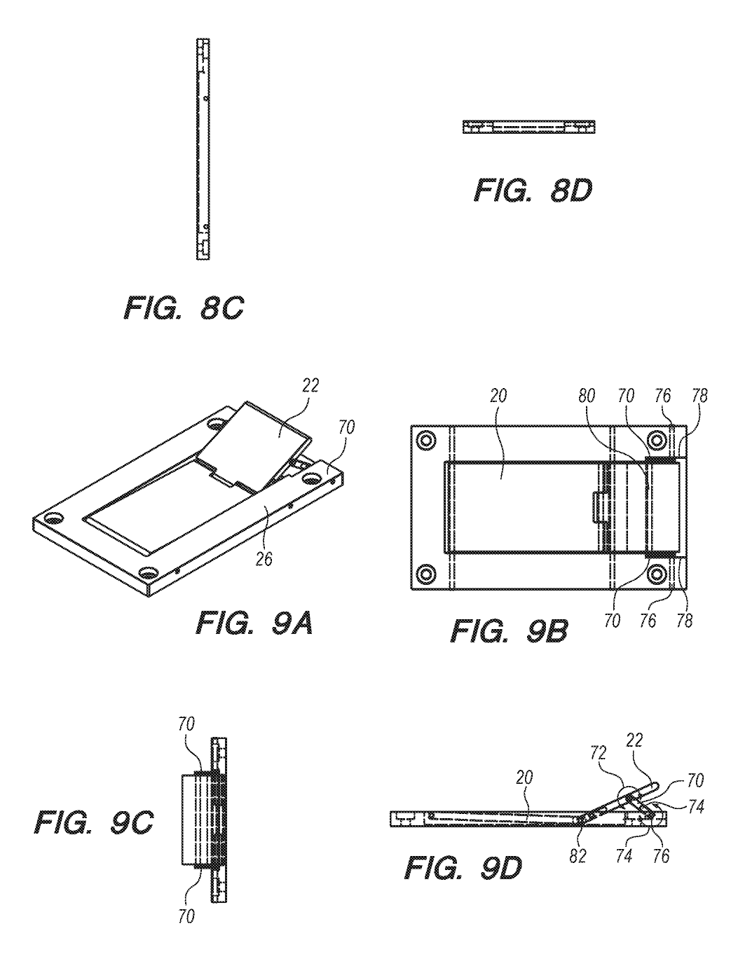

Referring now to FIGS. 8A-8D, the base 26 is shown. FIG. 8A is a perspective view of the base 26. FIG. 8B is a front view of the base 26. FIG. 8C is a right side view of the base 26. FIG. 8D is a top view of the base 26.

Referring now to FIGS. 9A-9D, a variant of the device 10 is shown wherein the braces 70 are secured to the base 26 and the stopper plate 22 on both sides of the stopper plate 22. The braces 70 may be pivotally attached to the stopper plate 22 and pivotally and slidably attached to the base 26. Directional arrow 72 shows that the braces 70 can be rotated in both directions with respect to the stopper plate 22. Directional arrow 72 shows that the braces 70 can be rotated in both directions with respect to the base 26. The braces 70 may also have slots 74 which allow pins 76 to slide there within.

The base 26 may also have cutouts 78 to accommodate the braces 70. The braces 70 may be pivotally attached to the stopper plate 22 by way of pin 80 and pivotally attached to the base 26 by way of pins 76 as discussed above.

During operation, the user may step down on the stepper plate 20 in order to lift the stopper plate 22 up as shown in FIG. 9D. Preferably, in this position, the intersection 82 of the stepper plate 20 and the stopper plate 22 may contact the floor of the cavity 36. Also, the pins 76 may contact the end of the slot 74. In the event that the door is opened when the stopper plate 22 is in the up position, the door pushes the stopper plate 22 and the force of the door is resisted by the braces 70. When the downward force on the stepper plate 20 is removed, the stopper plate 22 may be traversed back downward so that the door can be opened. The stopper plate 22 may be traversed downward by either the weight of the stopper plate and/or a spring force of the flat spring 59, torsion spring or other biasing force. The stepper plate 20 is traversed back upward.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A door stopper device for blocking a door in a closed position, the door stopper device comprising:
a base;
a stepper plate pivotally attachable to the base; and
a stopper plate pivotally attached to the base and the stepper plate, the stopper plate having a distal end portion opposite the stepper plate.

2. The door stopper device of claim 1, wherein the stepper plate is flush with the base when the door stopper device is in the disengaged position.

3. The door stopper device of claim 1, wherein the base includes at least one cavity to receive portions of the stepper plate and the stopper plate.

4. The door stopper device of claim 1, wherein the stepper plate and stopper plate are sized and structured such that the distal end portion of the stopper plate moves in a first direction upon application of a force to the stepper plate in an opposing second direction.

5. The door stopper device of claim 1, wherein the base is securable to the floor adjacent to the door, and the distal end portion of the stopper plate is raised upward and is engageable with the door when the door stopper device is in an engaged position, and the distal end of the stopper plate is lowered from the engaged position to assume a disengaged position, the stopper plate is not engageable with the door when the door stopper device is in the disengaged position.

6. The door stopper device of claim 5, wherein the stopper plate is translatable relative to the first pin.

7. The door stopper device of claim 6, wherein the stopper plate includes a slot sized to receive the first pin and facilitate translation of the stopper plate relative to the first pin.

8. The door stopper device of claim 5, further comprising a second pin affixed to the base and about which the stepper plate pivots.

9. The door stopper device of claim 8, further comprising a third pin pivotally connecting the stopper plate to the stepper plate.

10. The door stopper device of claim 1, wherein the base circumnavigates the stepper plate and the stopper plate.

11. A door stopper device for use with a door, the door stopper device comprising:
a base defining a base plane;
a press plate moveably engaged to the base; and
a stopper plate operatively coupled to the press plate and having a distal end portion, the stopper plate being transitional relative to the base between a disengaged position and an engaged position, a distance between the distal end portion and the base plane increasing as the stopper plate transitions from the disengaged position toward the engaged position.

12. The door stopper device of claim 11, wherein the press plate is parallel to the base plane when the stopper plate is in the disengaged position.

13. The door stopper device of claim 12, wherein the press plate is non-parallel relative to the base plane when the stopper plate is in the engaged position.

14. The door stopper device of claim 11, wherein the base includes at least one cavity to receive portions of the press plate and the stopper plate.

15. The door stopper device of claim 11, wherein the press plate and stopper plate are sized and structured such that the distal end portion of the stopper plate moves in a first direction upon application of a force upon the press plate in an opposing second direction.

16. The door stopper device of claim 11, further comprising a first pin affixed to the base and about which the stopper plate pivots.

17. The door stopper device of claim 16, wherein the stopper plate is translatable relative to the first pin.

18. The door stopper device of claim 17, wherein the stopper plate includes a slot sized to receive the first pin and facilitate translation of the stopper plate relative to the first pin.

19. The door stopper device of claim 16, further comprising a second pin affixed to the base and about which the press plate pivots.

20. A method of inhibiting movement of a door, the method comprising pivoting a press plate relative to a base from a first position toward a second position, the press plate being operatively connected to a stopper plate, such that pivoting of the press plate from the first position toward the second position causes the stopper plate to transition from a disengaged position toward an engaged position wherein the stopper plate is engageable with the door for inhibiting movement of the door.
